(19) United States
(12) Patent Application Publication
(10) Pub. No.: US 2005/0222904 A1
(43) Pub. Date: Oct. 6, 2005

(54) Prepaid monetary card for incentivizing return customers

(76) Inventors: Sandra Cotten, Huntington Beach, CA (US); Caroline Nakken, Whittier, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/814,814

(22) Filed: Mar. 31, 2004

(51) Int. Cl. G06F 17/60

(52) U.S. Cl. 705/14; 235/380; 235/375

(57) ABSTRACT

A system and methods are disclosed for incentivizing a customer to purchase goods and/or services at a later date through the use of a promotional purchase card. Some of the disclosed embodiments also gather consumer survey information for the customer. The card acquires value only after activation criteria have been satisfied, which may, by way of example, include a predetermined passage of time or the completion of one or more survey questions by the customer. The purchase card generally resembles a credit/debit card, having a sponsor name and logo, a card number, and a magnetic strip on the back of the card. In one embodiment, a retail store contracts with a promoter for a promotional purchase-card service comprising performing a promotion within the retail store. The promotional purchase-card service comprises selecting customers suitable for receiving the promotional purchase card that encourages the customers to answer one or more survey questions.

### BACKGROUND OF THE INVENTION

1. Field of the Invention

The present invention relates generally to the promotion of goods and/or services and, more particularly, relates to methods for incentivizing consumers to purchase goods and/or services whereby a consumer receives a purchase card that acquires value at a predetermined point in the future.

2. Description of the Related Art

Businesses, such as retail stores and service providers, generally desire to generate repeat customers that continue to return to the business to purchase goods and/or services. Towards this goal, businesses sometimes advertise price discounts, or distribute paper coupons that are redeemable for value when particular goods and/or services are purchased. Paper coupons are generally distributed either within circulated publications, such as newspapers or magazines, or at store sites. Paper coupons often are associated with an expiration date, after which the coupon is no longer redeemable.

Businesses also often desire to solicit from customers or potential customers information relating to their products or services. The information sought may be used by the businesses to help plan their future operations. For example, businesses may seek information that detects trends in customers' buying habits, which may be used to manage inventory, to optimize the purchasing and manufacturing of existing products, and to plan the development of new products. Businesses may also seek information that provides feedback on the effectiveness of product arrangement, product advertising, or other aspects of product marketing. Businesses often hire third parties to acquire the information they seek. Typically, the third parties will solicit responses to a questionnaire, or survey, from customers or potential customers. The surveys are typically administered in person, such as in a retail store or shopping mall, or in person over the telephone. Information gathering requires the customer or potential customer to exert some degree of time and effort. As such, incentives are sometimes used to motivate customers or potential customers to cooperate in the information gathering. Incentives may include the payment of a small amount of cash or the distribution of a store coupon.

### SUMMARY OF THE INVENTION

Methods are provided for incentivizing a consumer to purchase goods and/or services at a later time following a promotional event, whereby the consumer receives a promotional purchase card that acquires value at a later time. Optionally, the promotional purchase card acquires value upon the completion of a survey by the customer. The purchase card generally resembles a credit/debit card, having a sponsor name and logo, a card number, and a magnetic strip on the back of the card.

In one embodiment, future sales are incentivized by providing a promotional event at a provider of goods or services, providing an inactivated purchase card to a customer in association with the promotional event, and activating the purchase card at a future predetermined time.

In another embodiment, future sales are incentivized and customer survey information is gathered by providing an inactivated purchase card to a customer, providing survey questions to the customer, and activating the purchase card in response to receiving responses from the customer to the survey questions.

In another embodiment, future sales are incentivized and customer survey information is gathered by providing an inactivated purchase card to a customer, wherein the purchase card displays a telephone number to call to activate the card; receiving a telephone call from the customer at the telephone number; receiving from the customer during the telephone call a card identification number associated with the purchase card; providing to the customer during the telephone call one or more survey questions; receiving from the customer during the telephone call responses to the survey questions; and activating the purchase card with a predetermined value in response to receiving one or more responses from the customer to the survey questions.

In still another embodiment, future sales are incentivized and customer survey information is gathered by providing an inactivated purchase card to a customer, wherein said purchase card displays a URL for an internet web site for the customer to visit to activate the card; receiving a visit from the customer to the internet web site; receiving from the customer during the visit a card identification number associated with the purchase card; providing to the customer during the visit one or more survey questions; receiving from the customer during the visit responses to the survey questions; and activating the purchase card with a predetermined value in response to receiving one or more responses from the customer to the survey questions.

### BRIEF DESCRIPTION OF THE DRAWINGS

FIGS. 1A and 1B are front and rear perspective views, respectively, of a purchase card which can be used to gather information from a customer.

FIG. 2 is a block diagram illustrating one embodiment of the relationships between entities involved in transactions resulting from a customer utilizing the purchase card of FIGS. 1A and 1B.

FIG. 3 is a block diagram illustrating one embodiment of the relationships between entities involved in providing the purchase card of FIGS. 1A and 1B to customers.

FIG. 4 is a flow chart illustrating an embodiment of a process for incentivizing a future purchase by a customer receiving the purchase card of FIGS. 1A and 1B.

FIG. 5 is another flow chart illustrating an embodiment of a process for incentivizing a future purchase by a customer receiving the purchase card of FIGS. 1A and 1B.

FIG. 6 is another flow chart illustrating an embodiment of a process for incentivizing a future purchase by a customer receiving the purchase card of FIGS. 1A and 1B.

### DETAILED DESCRIPTION OF THE PREFERRED EMBODIMENT

The methods and systems disclosed herein relate to incentivizing future sales of goods and services to consumers. Some methods further relate to the gathering of survey information from consumers. Although certain preferred embodiments and examples are disclosed, it will be understood by those skilled in the art that the invention extends beyond the specifically disclosed embodiments to other alternative embodiments and uses of the invention and to obvious modifications and equivalents thereof. The scope of the invention disclosed herein is not limited by the particular disclosed embodiments described below.

Businesses often use price reductions to entice consumers to purchase goods and services. The price reductions may simply be in the form of a “sale,” which offers particular goods or services to all consumers at a discounted price (e.g., “25% off”) for a short duration of time. The price reductions may also be provided via paper coupons that entitle the bearer to a discount on particular goods or services. Typically such coupons are mass produced and included as inserts in newspapers or other widely distributed publications. To receive the discount, the consumer must present the coupon to a cashier or salesperson.

Paper coupons suffer from several drawbacks. First, they can be easily reproduced and altered. Second, paper coupons often do not restrict the time over which they may be used. Those coupons that do include a time restriction are generally redeemable immediately, and only include an expiration date. Third, paper coupons with expiration dates are often accepted after they expire by cashiers who fail to recognize that the purchase date exceeds the coupon expiration date. Fourth, paper coupons generally have redemption values that are static over time.

A purchase card provides advantages that provide businesses with greater flexibility than paper coupons for incentivizing future purchases. Unlike typical paper coupons, a purchase card is virtually impossible to reproduce. Security is also enhanced because a purchase card is read at the cashier station by a secure reader, as are credit and debit cards. Unlike typical paper coupons, a purchase card can easily be distributed in a de-activated state for a “waiting period” so that it does not acquire value until a later time. As such, a consumer receiving a purchase card during a visit to a retail store would not generally be able to use the card during that visit, but instead would have to return to the store later (e.g., the following week) to redeem the value of the card. The end of the “waiting period” may be defined in any number of ways. For example, activation can be set to occur on a fixed date (e.g., Feb. 19, 2004), after a fixed amount of time after the card has been provided to the consumer (e.g., one week after distribution), or after a required event has occurred (e.g., after the consumer has responded to a survey).

Another advantage of a purchase card is that its value can be changed over time. For example, a purchase card may be activated such that it contains one value on weekdays and a different value on weekends. A purchase card may also be activated such that it may only be used to purchase particular products (identifiable via bar code scanning at a cashier's station). A purchase card may also be activated such that it may only be used to purchase products at a particular store or branch of stores (identifiable by a store identification code associated with the card reader at the cashier's station).

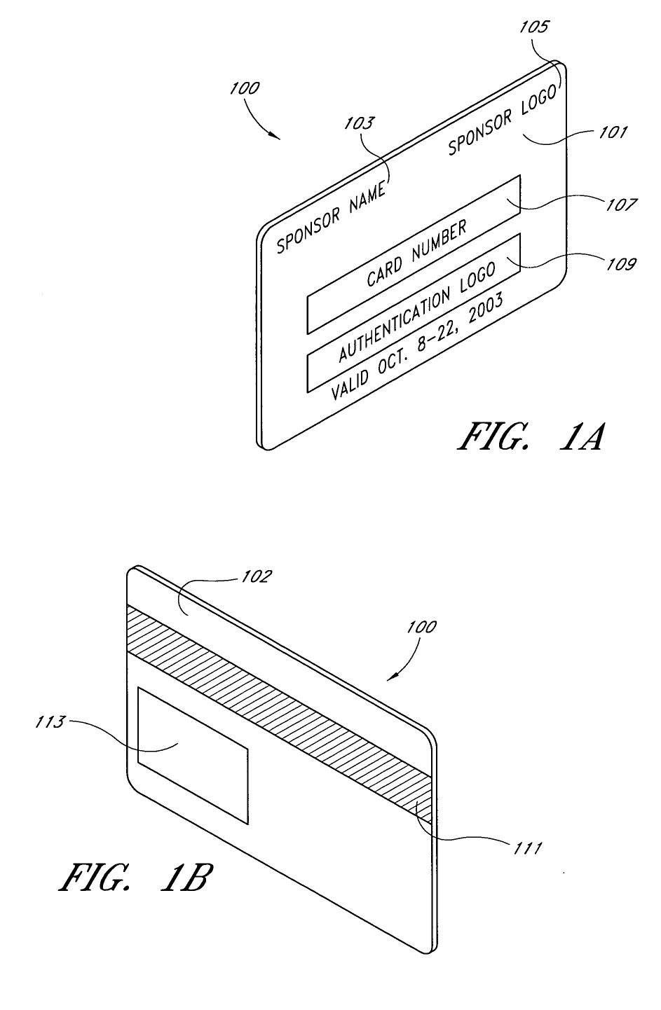

FIG. 1A illustrates one embodiment of the front 101 of a purchase card 100 that can be used to incentivize future sales of goods and services and facilitate the gathering of information from a customer or potential customer. FIG. 1B illustrates one embodiment of a back 102 of the purchase card 100. The card 100 can be a debit card, a credit card, a smart card, or another type of computer accessible storage medium. A credit card typically stores information on a magnetic strip of the credit card. A smart card typically stores information in a microchip of the smart card. Information can also be stored on other computer accessible storage medium such as floppy disks or optical disks. For convenience, all of the various embodiments are referred to in the present application as cards 100.

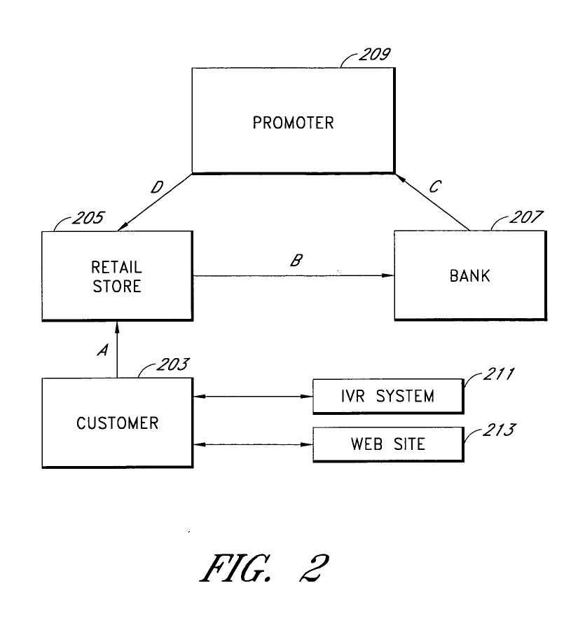

As shown in FIG. 1A, the purchase card 100 comprises a sponsor name 103, a sponsor logo 105, and a card number 107. Typically, the sponsor name 103 is the name of a vendor (e.g., a retail store) 205 (FIG. 2). The sponsor logo 105 may comprise a trademark associated with either the retail store 205 or a promoter 209 (FIG. 2). As shown in FIG. 1B, an authentication logo 109 may also be included on the card 100. The authentication logo 109 generally provides visual proof of the validity of the card 100 when presented by the customer to personnel employed by the retail store 205 or the promoter 209.

As shown in FIG. 1B, the back 102 of the card 100 comprises a magnetic strip 111. The magnetic strip 111 generally stores card information such as, for example, a card number 107, a total purchase amount loaded on the card 100, and an identification number assigned to the card 100. In one embodiment, the identification number comprises a personal identification number (PIN) assigned to respective cards 100. An information section 113 may also be included on the back 102 of the card. The information section 113 may advantageously be utilized to show additional information that is not desired or appropriate for placement on the front 101 of the card 100. The information section 113 may include, but is not limited to, contact information about the sponsor of the card 100, information about the retail store 205, information on card activation, a telephone number for problems, or information about the bank 207 that provides purchasing credit to the card 100.

FIG. 2 is a block diagram illustrating one embodiment of the relationships between entities involved in a transaction resulting from a customer utilizing the purchase card 100. The entities include a customer 203, the retail store 205, a bank 207, and the promoter 209. In one embodiment, the customer must engage in a dialog with an Interactive Voice Response (IVR) system 211 via telephone to activate the card 100. The IVR system 211 may be managed by any of the other entities or by a third party. In another embodiment, the customer must communicate with a web site 213 via the internet to activate the card 100. The web site 213 may be hosted by any of the other entities or by a third party. The retail store 205 can be any vendor that sells products or services associated with a promotion designed to elicit customer feedback. Generally, the retail store 205 is a vendor that provides a plurality of products for purchase by the customers 203. The retail store 205 can also be a service vendor that provides services. For example, the service vendor can be a travel agent, a transportation company, a financial brokerage firm, a real estate agency, an Internet service provider, and the like. The promoter 209 generally provides promotional cards (e.g., the purchase card 100) to the retail store 205 for distribution to the customers 203. The bank 207 can be any financial institution that issues credit/debit cards. Optionally, the bank 207 can include a collection of banks and/or other financial institutions (e.g., a credit card service that issues debit cards).

As further shown in FIG. 2, the customer 203 generally uses the card 100 to purchase items at the retail store 205. When the customer 203 makes a purchase, in a transaction A, the retail store 205 swipes the card (i.e., moves the magnetic strip 111 of the card with respect to a sensor on a card reader (not shown)). In a transaction B, the card 100 PIN and ID number are each forwarded from the retail store 205 to the bank 207. The bank 207 verifies that the forwarded card PIN and ID number match the card PIN and ID number stored at the bank 207, authorizes the retail store 205 purchase, and reduces a balance on the card 100 by a purchase amount. Responsive to the services performed in the transaction B, the bank 207 charges the promoter 209 a service fee in a transaction C. The promoter 209 then charges the retail store 205 a service fee in a transaction D in exchange for providing the purchase card 100 and the purchase card service, to the retail store 205. The service fee charged by the promoter 209 to the retail store 205 may include the fee charged by the bank 207 to the promoter 209.

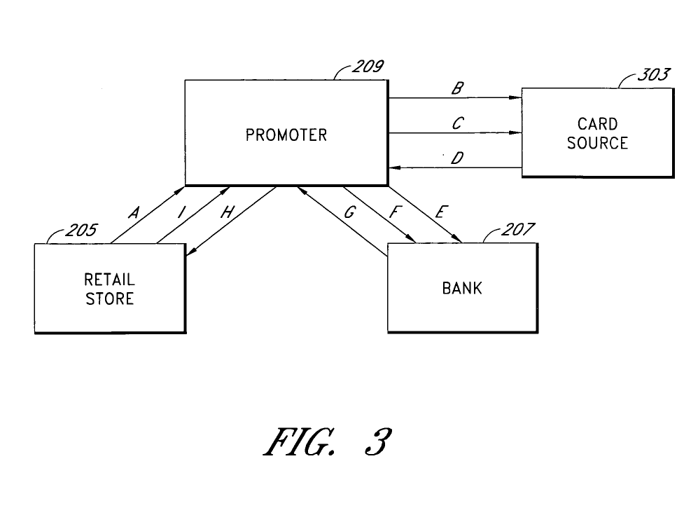

FIG. 3 is a block diagram illustrating one embodiment of the relationships between the entities involved in providing the purchase cards 100 to the retail store 205 for distribution to the customers 203. The entities include the retail store 205, the bank 207, the promoter 209, and a card source 303. The card source 303 preferably is a financial institution that issues credit/debit cards, and preferably is capable of providing bulk quantities of the purchase cards 100 upon request by the promoter 209.

As further shown in a transaction A of FIG. 3, the retail store 205 engages the promoter 209 to manage a promotion. The promoter 209 is contracted by the retail store 205 to provide an in-store “promotional purchase-card service.” Such a promotional purchase-card service preferably includes giving each suitable customer at least one purchase card 100 to enable the customer to purchase one or more items within the retail store 205; however, as discussed below, the customer must participate in a survey before the purchase card 100 is activated. Generally, suppliers of brand name products sold by retail store 205 provide the money that is associated with the purchase cards 100. This may involve up-front payments before the cards are loaded, or it may involve later payments after the cards have been used to make purchases. In a transaction B and a transaction C of FIG. 3, the promoter 209 purchases a quantity of purchase cards 100 from the card source 303. In the transaction B, the promoter 209 supplies the card source 303 with the sponsor name 103, the sponsor logo 105, and the card numbers 107. The promoter 209 may also supply the card source 303 with the authentication logo 109 and any information suitable for placement in the information section 113 on the back 111 of the purchase cards 100. In the transaction C, the promoter 209 transfers money to the card source 303 in exchange for the quantity of cards 100. In a transaction D, the promoter 209 receives the quantity of purchase cards 100 from the card source 303.

Once the promoter 209 has the purchase cards 100 requested by the retail store 205, the promoter 209 sends the cards to the bank 207 in a transaction E of FIG. 3. In a transaction F, the promoter 209 sends money to the bank 207 in an amount to be credited to the cards 100. In the transaction F, the promoter 209 may also send the bank 207 a fee for the bank's services. The bank 207 stores information on the magnetic strip 111 of the purchase card 100. That information may be a card number 107 or an identification number assigned to the card 100. Optionally, the bank 207 may also store the total purchase amount credited to the card 100 onto the magnetic strip 111 using suitable commercially available techniques that preclude unauthorized modification of the purchase amount. Alternatively, the purchase amount may be stored in an external database managed by the bank 207, such that the purchase amount is correlated to a unique identification number associated with the card. In a transaction G, the promoter 209 receives the credited purchase cards 100 from the bank 207. Then, in transaction H, the promoter 209 provides the purchase cards 100 to the retail store 205. Upon receiving the purchase cards 100, the retail store 205 sends payment to the promoter 209 for the promotional purchase card service in a transaction I. The payment includes the cost of the purchase cards 100, production costs, and any other required fees. The retail store 205 can then distribute the purchase cards to the customers 203 as discussed above in connection with FIG. 2.

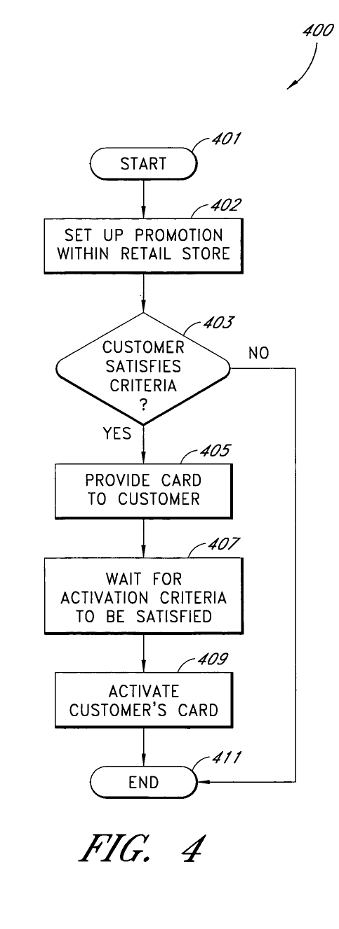

FIG. 4 is a flow chart illustrating one embodiment of a process 400 for incentivizing a future purchase by a customer 203 requesting activation of the purchase card 100. The process 400 begins at a block 401 and then advances to a decision block 402 where the promoter 209 sets up a promotional event within the retail store 205. The promotional event can be of any kind intended to attract consumers to a particular product, including but not limited to live commercials, retail entertainment, presentations, offerings of samples, and contests. The promotional event advantageously attracts customers 203 within the retail store 205. When the customer 203 expresses an interest in or participates in the promotion, the process 400 advances to a decision block 403 where the promoter 209 determines whether the customer 203 is entitled to receive the purchase card 100. In one embodiment, only those customers 203 that satisfy certain criteria are considered suitable for receiving the purchase card 100. Such criteria can include, but are not limited to, purchasing predetermined products, winning a contest, achieving a predetermined score in a competition, and the like. In another embodiment, the purchase card 100 may be provided to anyone who wants one. If the customer 203 does not satisfy the criteria, the process 400 ends at a block 411 without giving a purchase card 100 to the customer 203.

If the customer 203 satisfies the criteria, the process 400 advances from the decision block 403 to a block 405 where the promoter 209 provides the purchase card 100 to the customer 203. In one embodiment, the purchase card 100 is manually provided to the customer 203, such as by representatives or personnel employed by the retail store 205 or the promoter 209 handing the card to the customer 203. In another embodiment, the promoter 209 automatically dispenses the purchase card 100 to the customer 203 by an automated dispensing device located in the retail store 205.

Note that the purchase card 100 is not enabled at the time it is dispensed to the customer 203. In one embodiment, the customer 203 lacks a personal identification number (“PIN”) for the card 100. In another embodiment, the card 100 has not been activated. In still another embodiment, the card 100 has a zero credit balance. Preferably, the purchase card 100 includes, or is accompanied by, information that informs the customer 203 how to activate the card 100. This information may include a date upon which the card becomes active, and a date upon which the card expires. This information may also include a phone number, a Universal Resource Locator (URL), or both, printed on the purchase card 100, directing the customer 203 to contact the promoter 209 by telephone or by accessing the Internet to activate the card 100. In another embodiment, the phone number, the URL, or both are printed on a separate sheet accompanying the purchase card 100. In still another embodiment, the separate sheet may comprise one or more questions that the customer 203 must answer in order to activate the purchase card 100. Moreover, the separate sheet may take the form of an answer sheet whereon the customer 203 selects answers to the questions, and then mails the sheet to the promoter 209 as directed.

Once the customer 203 is provided with the purchase card 100, the process 400 advances to a block 407 where the customer 203 must wait to use the purchase card 100 until activation criteria have been satisfied. The activation criteria ensures that the purchase card 100 will not acquire value until a later time. The activation criteria may be defined in any number of ways. For example, activation can be set to occur on a fixed date, a fixed amount of time after the card has been provided to the consumer, or after a required event has occurred.

In one embodiment, the activation criteria require that the customer first complete one or more survey questions that are given to the customer 203 manually (e.g., verbally in person or via the telephone), such as by a representative or employee of the retail store 205 or the promoter 209. In another embodiment, the survey questions are given to the customer 203 automatically, such as by IVR via telephone, or by presenting the customer 203 with a form or web page via the Internet. The responses of the customer 203 to the survey questions are received and recorded in the block 407. The recording of the responses may take place manually (by a representative of the retail store 205 or the promoter 209), via audio recording over the telephone (as is well known in the art of IVR), via receiving telephone keypad entries, or via the filling out of a form or web page, as is appropriate.

Once the activation criteria are satisfied, the process 400 advances to a block 409 where the customer's card 100 is activated for use in the retail store 205. In one embodiment, the card 100 is activated by providing the customer 203 with a PIN for the card. In another embodiment, the card 100 is activated by applying a credit balance to the card 100. In other embodiments, the card 100 may be activated by any action that renders the purchase card 100 useable. Once the customer's card 100 is activated, the process 400 ends at a block 411.

Preferably, the purchasing power of the purchase card 100 is limited so as to prevent unlimited purchasing by the customer 203. In one embodiment, the card 100 is time limited. For example, after the card 100 is activated, the customer 203 has a limited period of time following activation during which to use the card 100 to make a purchase. After the period of time elapses, the purchase card 100 is deactivated and is no longer useable by the customer 203. In another embodiment, the purchase card 100 may be limited to certain branches or locations of the retail store 205, or the purchase card 100 may be limited to certain departments within one branch of the retail store 205. In still another embodiment, the purchase card 100 is limited to the purchase of only certain products within the retail store 205. It will be appreciated that in other embodiments, one or more of the foregoing limitations, as well as other limitations, can be combined to set further restrictions on the customer's use of the purchase card 100. The information defining the limitations associated with a particular purchase card 200 may be stored on the card itself. Alternatively, the information may be stored in a separate database (for example, at the bank 207) that is uniquely associated with the card 200 and that is accessible to the card authentication systems in use at retail stores.

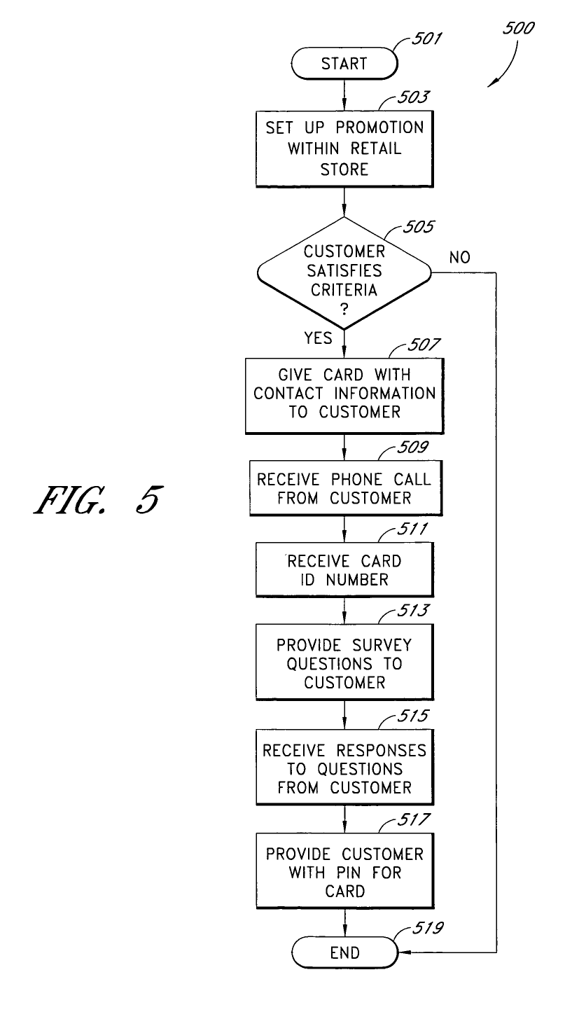

FIG. 5 is a flow chart illustrating an embodiment of a process 500 for gathering information from a customer 203 through a telephone communication between the customer 203 and the IVR system 211. The process 500 begins at a block 501 and then advances to a block 503 where the promoter 209 sets up a promotional event within the retail store 205. When the customer 203 expresses an interest in the promotion, the process 500 advances to a decision block 505 where the promoter 209 determines whether the customer 203 is entitled to receive the purchase card 100. For example, a promotion associated with the NCAA Basketball Final Four tournament may only provide purchase cards 100 to customers who successfully shoot a toy basketball into a toy basketball hoop. If the customer 203 does not satisfy the selection criteria, the process 500 ends at a block 519 without the customer 203 receiving a purchase card 100.

If the customer 203 satisfies the criteria, the process 500 advances to a block 507 where the promoter 209 provides the purchase card 100 to the customer 203. The purchase card 100 can be manually provided to the customer 203, such as by personnel employed by the retail store 205 or the promoter 209 handing the card to the customer 203, or can be automatically dispensed to the customer 203 by an automated dispensing device.

The purchase card 100 is not activated upon being dispensed to the customer 203. Rather, in this embodiment the purchase card 100 displays a telephone number, preferably toll free, that the customer 203 must call in order to activate the card 100. That telephone number is associated with the IVR system 211, which is programmed with the survey that must be taken before the card 100 is activated.

In block 509, the IVR system receives the telephone call from the customer 203 at the telephone number provided on the card 100. Blocks 511, 513, 515 and 517 describe a dialog that takes place between the customer and the IVR system 211. That dialog comprises prerecorded messages loaded onto the IVR system 211 and responses of the customer 203 to those messages, as is well known in the art. Preferably, the IVR system is programmed with messages in multiple languages to accommodate as many customers or potential customers as possible. In block 511, the IVR system 211 requests the ID number associated with the customer's purchase card 100. The customer may read the ID number from the card and provide it the IVR system 211 through normal speech or telephone keypad entry. Once the ID number is received, the process 500 advances to a block 513, where the IVR system 211 provides the customer 203 with prerecorded messages containing one or more survey questions.

In a block 515, the customer's responses to the survey questions are received and recorded by the IVR system 211. It is understood that blocks 513 and 515 may be repeated multiple times as needed to receive responses to multiple survey questions. After the customer 203 has provided the IVR system 211 with sufficient responses to the prerecorded survey questions, the process 500 advances to a block 517 where the IVR system 211 provides the customer 203 with a PIN number associated with the ID number of the card 100 received previously from the customer 203. That PIN number enables the card 100 for use. Once the PIN number is provided to the customer 203, the process 500 ends at a block 519.

As discussed above, the purchasing power of the purchase card 100 may be limited in many ways. These may include a limited duration of activation, limited store branches or locations, and limited products or services.

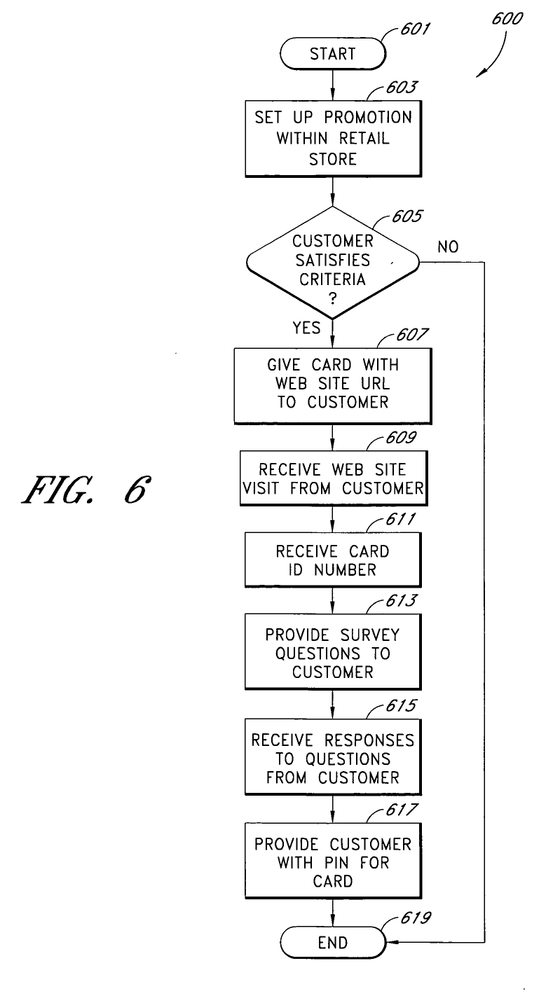

FIG. 6 is a flow chart illustrating an embodiment of a process 600 for gathering information from a customer 203 through a visit by the customer 203 to the web site 213. The process 600 begins at a block 601 and then advances to a block 603 where the promoter 209 sets up a promotional purchase-card service, as described above for block 503. In block 605, the promoter 209 determines whether the customer 203 is entitled to receive the purchase card 100. If the customer 203 does not satisfy the criteria, the process 600 ends at a block 617 without giving a purchase card 100 to the customer 203.

If the customer 203 satisfies the criteria, the process 600 advances to a block 607 where the promoter 209 provides the purchase card 100 to the customer 203. As discussed above, the card 100 may be provided to the customer 203 in a variety of ways. In the embodiment of FIG. 6, the purchase card 100 displays a URL for the web site 213 that the customer 203 must access via a web browser in order to activate the card 100. The web site 213 is associated with the survey that must be taken before the card 100 is activated.

In block 609, the web site 213 receives a visit from the customer 203 at the URL provided on the card 100. Blocks 611, 613, 615 and 617 describe an interaction that takes place between the customer and the web site 213. That interaction is facilitated by one or more web pages of the web site 213 containing pull down menus, text fields, buttons, or other web page tools that enable the receiving of information from visitors to the web pages, as is well known in the art.

In block 611, the web site 213 requests the ID number associated with the customer's purchase card 100. The customer may read the ID number from the card and provide it the web site 213. Once the ID number is received, the process 600 advances to a block 613, where the web site 213 provides the customer 203 with one or more survey questions.

In a block 615, the customer's responses to the survey questions are received and recorded by the web site 213. It is understood that blocks 613 and 615 may be repeated multiple times as needed to receive responses to multiple survey questions. The web site 213 may advantageously use images, video files, and audio files as part of the survey process. In one embodiment, the questions presented by the web site 213 are based in part upon the responses provided by the customer 203.

After the customer 203 has provided the web site 213 with sufficient responses to the survey questions, the process 600 advances to a block 617 where the web site 213 provides the customer 203 with a PIN number associated with the ID number of the card 100 received previously from the customer 203. That PIN number enables the card 100 for use. Once the PIN number is provided to the customer 203, the process 600 ends at a block 619.

As discussed above, the purchasing power of the purchase card 100 may be limited temporally, to certain stores or branches of stores, or to certain products. It will be appreciated that these limitations, as well as other limitations, can be combined to set further restrictions on the customer's 203 use of the purchase card 100.

Once the customer's purchase card 100 is activated, the promoter 209 provides the results of the survey questions collected in the block 515 or in the block 615 to the retail store 205 or other interested parties, as is appropriate. The survey results from a plurality of customers in the block 515 and/or the block 615 may be analyzed to provide the information sought by the vendor or other interested parties.

Although preferred embodiments and methods have been described in detail, certain variations and modifications thereof will be apparent to those skilled in the art, including embodiments and/or methods that do not provide all of the features and benefits described herein. Accordingly, the scope of the above-discussed embodiments and methods is not to be limited by the illustrations or the foregoing descriptions thereof, but rather solely by the appended claims.

1. A method of incentivizing future purchases by customers, said method comprising:
providing a promotional event at a provider of goods or services;
providing an inactivated purchase card to a customer in association with said promotional event; and
activating said purchase card at a future predetermined time.

2. The method of claim 1, wherein said purchase card is provided to the customer only if the customer satisfies one or more predetermined criteria.

3. The method of claim 1, wherein said future predetermined time is a predetermined duration after said inactivated purchase card is provided to the customer.

4. The method of claim 1, wherein said future predetermined time is determined by the receipt of responses from the customer to survey questions.

5. The method of claim 1, further comprising de-activating said purchase card at a second predetermined time that occurs after said future predetermined time.

6. The method of claim 1, wherein said purchase card is activated to only allow the purchase of goods or services offered by said provider.

7. The method of claim 1, wherein said purchase card is activated to only allow the purchase of goods or services associated with said promotional event.

8. A method of incentivizing future purchases by customers, said method comprising:
providing an inactivated purchase card to a customer;
providing survey questions to the customer; and
activating said purchase card in response to receiving responses from the customer to said survey questions.

9. The method of claim 8, wherein said purchase card is provided to the customer only if the customer satisfies one or more predetermined criteria.

10. The method of claim 8, wherein said purchase card is provided to the customer manually.

11. The method of claim 8, wherein said purchase card is provided to the customer automatically.

12. The method of claim 8, wherein said purchase card is provided to the customer in association with a promotional event at a provider of goods or services.

13. The method of claim 12, wherein said purchase card is activated to only allow the purchase of goods or services offered by said provider.

14. The method of claim 12, wherein said purchase card is activated to only allow the purchase of goods or services associated with said promotional event.

15. A method of incentivizing future purchases by customers, said method comprising:
providing an inactivated purchase card to a customer, wherein said purchase card displays a telephone number to call to activate the card;
receiving a telephone call from the,customer at said telephone number;
receiving from the customer during said telephone call a card identification number associated with said purchase card;
providing to the customer during said telephone call one or more survey questions;
receiving from the customer during said telephone call responses to said survey questions; and
activating said purchase card with a predetermined value in response to receiving one or more responses from the customer to said survey questions.

16. The method of claim 15, wherein said purchase card is provided to the customer only if the customer satisfies one or more predetermined criteria.

17. The method of claim 15, wherein said purchase card is provided to the customer manually.

18. The method of claim 15, wherein said purchase card is provided to the customer automatically.

19. The method of claim 15, wherein said activating comprises providing the customer with a personal identification number associated with said purchase card.

20. The method of claim 15, wherein said activating comprises applying a credit balance to said purchase card.

21. The method of claim 19, further comprising disabling the personal identification number associated with said purchase card after a predetermined amount of time.

22. The method of claim 20, further comprising setting to zero the credit balance associated with said purchase card after a predetermined amount of time.

23. The method of claim 15, further comprising providing the customer with instructions to call said telephone number to activate said purchase card.

24. The method of claim 15, wherein said survey questions are provided to the customer as prerecorded messages accessible at said telephone number.

25. The method of claim 24, wherein said responses are received from the customer via an interactive voice response system accessible at said telephone number.

26. A method of incentivizing future purchases by customers, said method comprising:
providing an inactivated purchase card to a customer, wherein said purchase card displays a URL for an internet web site for the customer to visit to activate the card;
receiving a visit from the customer to said internet web site;
receiving from the customer during said visit a card identification number associated with said purchase card;
providing to the customer during said visit one or more survey questions;
receiving from the customer during said visit responses to said survey questions; and
activating said purchase card with a predetermined value in response to receiving one or more responses from the customer to said survey questions.

27. The method of claim 26, wherein said purchase card is provided to the customer only if the customer satisfies one or more predetermined criteria.

28. The method of claim 26, wherein said purchase card is provided to the customer manually.

29. The method of claim 26, wherein said purchase card is provided to the customer automatically.

30. The method of claim 26, wherein said activating comprises providing the customer with a personal identification number associated with said purchase card.

31. The method of claim 26, wherein said activating comprises applying a credit balance to said purchase card.

32. The method of claim 30, further comprising disabling the personal identification number associated with said purchase card after a predetermined amount of time.

33. The method of claim 31, further comprising setting to zero the credit balance associated with said purchase card after a predetermined amount of time.

34. The method of claim 26, further comprising providing the customer with instructions to visit said web site to activate said purchase card.

35. The method of claim 26, wherein said survey questions are provided to the customer on one or more web pages associated with said web site.

36. The method of claim 26, wherein said responses are received from the customer via user interfaces on one or more web pages associated with said web site.
